(19) United States
(12) Patent Application Publication
(10) Pub. No.: US 2012/0102085 A1
(43) Pub. Date: Apr. 26, 2012

(54) RESOURCE ADAPTER FOR INBOUND AND OUTBOUND COMMUNICATIONS IN AN APPLICATION SERVER

(75) Inventor: Eugene Joseph Gretter, Lino Lakes, MN (US)

(73) Assignee: Unisys Corp., Blue Bell, PA (US)

(21) Appl. No.: 12/909,993

(22) Filed: Oct. 22, 2010

(51) Int. Cl. G06F 15/16

(52) U.S. Cl. 709/201; 709/227; 714/E11.025

(57) ABSTRACT

A resource adapter may include an inbound connection from an information server and an outbound connection to the information server. A resource adapter of the application server may listen for request messages on the inbound connection. Session beans in an enterprise container of the application server containing the resource adapter performs tasks requested in the request messages. Response messages are transmitted by the resource adapter through the outbound connection to the application server. The session beans may perform calculations for the information server or access data for the information server. The request messages may be generated by a JavaScript executing in the information server.

### TECHNICAL FIELD

The instant disclosure relates to an application server. More specifically, the disclosure relates to an application server for mobile applications with inbound and outbound communications.

### BACKGROUND

Application servers executing computer code have conventionally connected to an information server to push information to the information server. For example, an application server may push information from a computer program executing on the application server to the information server. Conventional application servers only have outbound communications to the information server. Thus, the application server is unable to receive requests for computer programs executing on the application server from the information server.

### SUMMARY

According to one embodiment, a method includes listening on a network port for a network connection request from an information server. The method also includes establishing a socket connection with the information server after the network connection request is received. The method further includes receiving a request message through the socket connection. The method also includes identifying a session bean to respond to the request message. The method further includes sending a response message to the information server.

According to another embodiment, an application server includes an enterprise container for performing operations requested by an information server. The application server also includes a resource adapter for processing an inbound connection from and an outbound connection to the information server.

According to yet another embodiment, a computer program product includes a computer-readable medium having code to listen on a network port for a network connection request from an information server. The medium also includes code to establish a socket connection with the information server after the network connection request is received. The medium further includes code to receive a request message through the socket connection. The medium also includes code to identify a session bean to respond to the request message. The medium further includes code to send a response message to the information server.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating an information system according to one embodiment of the disclosure.

FIG. 2 is block diagram illustrating a data management system configured to store information capable of access through session beans on an application server according to one embodiment of the disclosure.

FIG. 3 is a block diagram illustrating an application server according to one embodiment of the disclosure.

FIG. 4 is a block diagram illustrating an resource adapter having inbound and outbound communications according to one embodiment.

FIG. 5 is a flow chart illustrating a method for handling inbound communications with a resource adapter according to one embodiment.

### DETAILED DESCRIPTION

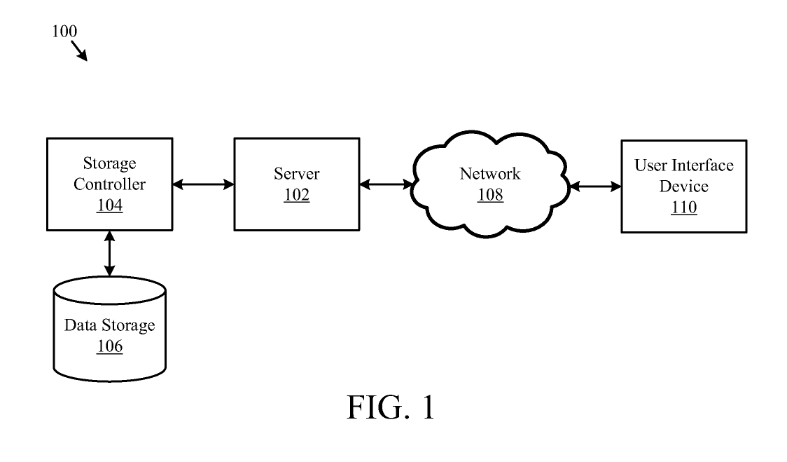

FIG. 1 illustrates one embodiment of a system 100 for an information system. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108.

In one embodiment, the user interface device 110 is referred to broadly and is intended to encompass a suitable processor-based device such as a desktop computer, a laptop computer, a personal digital assistant (PDA) or table computer, a smartphone or other a mobile communication device or organizer device having access to the network 108. In a further embodiment, the user interface device 110 may access the Internet or other wide area or local area network to access a web application or web service hosted by the server 102 and provide a user interface for enabling a user to enter or receive information.

The network 108 may facilitate communications of data between the server 102 and the user interface device 110. The network 108 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 102 is configured to execute session beans in a container. Additionally, session beans on the server 102 may access data stored in the data storage device 106 via a Storage Area Network (SAN) connection, a LAN, a data bus, or the like. The data storage device 106 may include a hard disk, including hard disks arranged in an Redundant Array of Independent Disks (RAID) array, a tape storage drive comprising a magnetic tape data storage device, an optical storage device, or the like. The data may be arranged in a database and accessible through Structured Query Language (SQL) queries, or other data base query languages or operations.

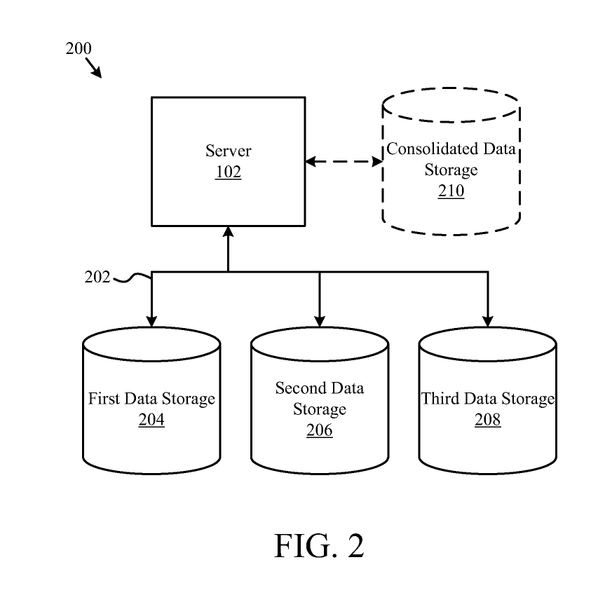

FIG. 2 illustrates one embodiment of a data management system 200 configured to provide data access for session beans. In one embodiment, the data management system 200 may include a server 102. The server 102 may be coupled to a data-bus 202. In one embodiment, the data management system 200 may also include a first data storage device 204, a second data storage device 206, and/or a third data storage device 208. In further embodiments, the data management system 200 may include additional data storage devices (not shown). In such an embodiment, each data storage device 204, 206, 208 may each host a separate database that may, in conjunction with the other databases, contain redundant data. Alternatively, the storage devices 204, 206, 208 may be arranged in a RAID configuration for storing a database or databases through may contain redundant data.

In one embodiment, the server 102 may submit a query to selected data from the storage devices 204, 206. The server 102 may store consolidated data sets in a consolidated data storage device 210. In such an embodiment, the server 102 may refer back to the consolidated data storage device 210 to obtain a set of data elements at the request of a session bean. Alternatively, the server 102 may query each of the data storage devices 204, 206, 208 independently or in a distributed query to obtain the set of data elements. In another alternative embodiment, multiple databases may be stored on a single consolidated data storage device 210.

In various embodiments, the server 102 may communicate with the data storage devices 204, 206, 208 over the data-bus 202. The data-bus 202 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 102 may communicate indirectly with the data storage devices 204, 206, 208, 210; the server 102 first communicating with a storage server or the storage controller 104.

The server 102 may include modules for interfacing with the data storage devices 204, 206, 208, 210, interfacing a network 108, interfacing with a user through the user interface device 110, and the like. In a further embodiment, the server 102 may host an engine, application plug-in, or application programming interface (API).

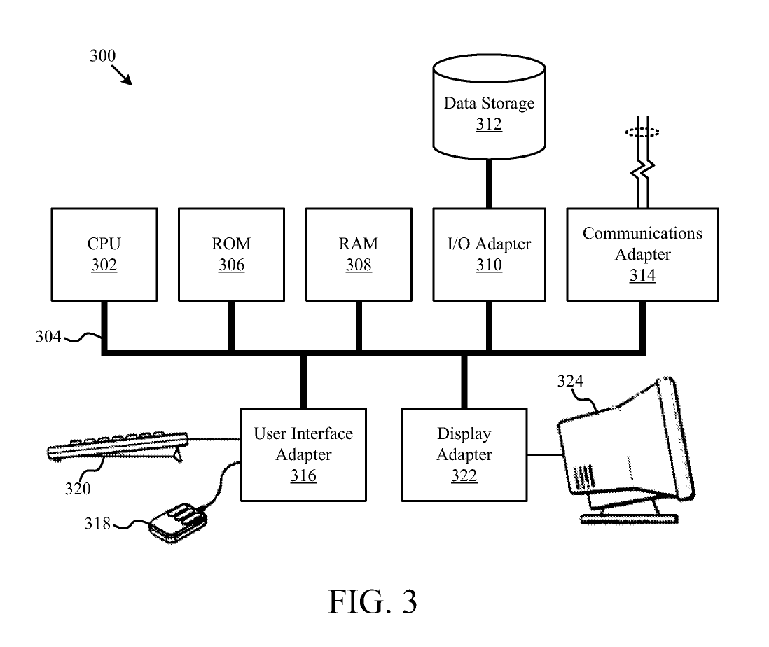

FIG. 3 illustrates a computer system 300 adapted according to certain embodiments of the server 102 and/or the user interface device 110. The central processing unit (“CPU”) 302 is coupled to the system bus 304. The CPU 302 may be a general purpose CPU or microprocessor, graphics processing unit (“GPU”), microcontroller, or the like. The present embodiments are not restricted by the architecture of the CPU 302 so long as the CPU 302, whether directly or indirectly, supports the modules and operations as described herein. The CPU 302 may execute the various logical instructions according to the present embodiments.

The computer system 300 also may include random access memory (RAM) 308, which may be SRAM, DRAM, SDRAM, or the like. The computer system 300 may utilize RAM 308 to store the various data structures used by a software application having code to execute session beans in a container. The computer system 300 may also include read only memory (ROM) 306 which may be PROM, EPROM, EEPROM, optical storage, or the like. The ROM may store configuration information for booting the computer system 300. The RAM 308 and the ROM 306 hold user and system data.

The computer system 300 may also include an input/output (I/O) adapter 310, a communications adapter 314, a user interface adapter 316, and a display adapter 322. The I/O adapter 310 and/or the user interface adapter 316 may, in certain embodiments, enable a user to interact with the computer system 300. In a further embodiment, the display adapter 322 may display a graphical user interface associated with a software or web-based application. For example, the display adapter 322 may display menus allowing an administrator to change configuration settings on the server 102 through the user interface adapter 316.

The I/O adapter 310 may connect one or more storage devices 312, such as one or more of a hard drive, a compact disk (CD) drive, a floppy disk drive, and a tape drive, to the computer system 300. The communications adapter 314 may be adapted to couple the computer system 300 to the network 108, which may be one or more of a LAN, WAN, and/or the Internet. The user interface adapter 316 couples user input devices, such as a keyboard 320 and a pointing device 318, to the computer system 300. The display adapter 322 may be driven by the CPU 302 to control the display on the display device 324.

The applications of the present disclosure are not limited to the architecture of computer system 300. Rather the computer system 300 is provided as an example of one type of computing device that may be adapted to perform the functions of a server 102 and/or the user interface device 110. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

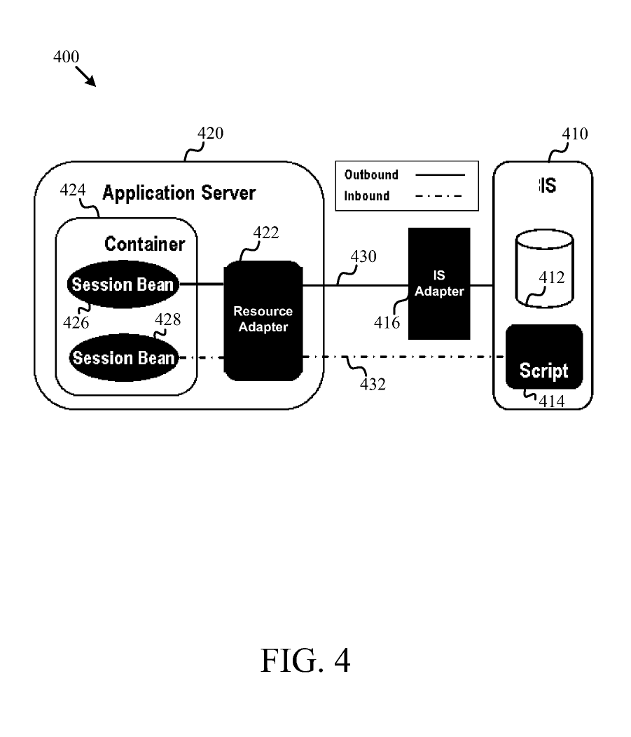

FIG. 4 is a block diagram illustrating an resource adapter having inbound and outbound communications according to one embodiment. A system 400 includes an information server 410 having a database 412 and script routines 414. The script routines 414 may be JavaScripts or scripts or code written in other programming languages. The system 400 also includes an application server 420 having a resource adapter (RA) 422 and an application container 424. According to one embodiment, the information server 410 may be a business information server (BIS), and the resource adapter 422 may be a BIS-RA. The application container 424 may be, for example, an enterprise javabeans (EJB) container including session beans 426, 428. The application server 420 may have an outbound communication connection 430 to the information server 410 through a information server adapter 416. The information server adapter 416 may be a JBIS adapter. The resource adapter 422 may have an inbound communication connection 432 from the information server 410. The inbound communication connection 432 may allow a script routine 414 to send request messages to the resource adapter 422. According to one embodiment, the inbound communication connection 432 and/or the outbound communication connection 430 supports secure connections such as secure socket layers (SSL) connections.

According to one embodiment, the resource adapter 422 may be a system-level software driver used by the container 424 to connect to an enterprise information server. The resource adapter 422 may be available as a library and used within the address space of a server or client. The resource adapter 422 may plug in to the container 424 to allow the session beans 426, 428 deployed in the container 424 to use the client application programming interface (API) and/or tool-generated high-level abstractions to access the information server 410.

The resource adapter 422 may be configurable by an administrator of the application server 420. For example, the administrator may configure a CharacterSet configuration to specify the character set of string values passed between the application server 420 and the information server 410. According to one embodiment the CharacterSet defaults to ISO8859-1. The CharacterSet may be configurable on the outbound communication connection 430 and/or the inbound communication connection 432. In another example, the administrator may configure a ClientLoginImplClass configuration to specify the name of a ClientLogin class used by the resource adapter 422 to perform user authentication such as a client login. In yet another example, the network port for listening to requests may be configured by an administrator through a ListenerPort setting on the application server. Additionally, the administrator may configure a MessageBacklog configuration to define the number of incoming connection requests that may be waiting at the application server 420. In another example, the administrator may configure a ProviderURL configuration to define the universal resource locator (URL) to locate a naming service.

The session beans 426, 428 may be created by a remote client (not shown) and exist for the duration of a single client-server session. The session bean 426, 428 performs operations, such as calculations or database access, for the remote client. Although the session beans 426, 428 may be transactional, they may or may not be recoverable if the application server 420 fails. The session beans 426, 428 may be stateless or may maintain conversational state across methods and transactions. If the session beans 426, 428 maintain states then the container 424 manages this state if the session beans 426, 428 are removed from memory. Although only two session beans are illustrated in FIG. 4, additional session beans may be present in the container 424.

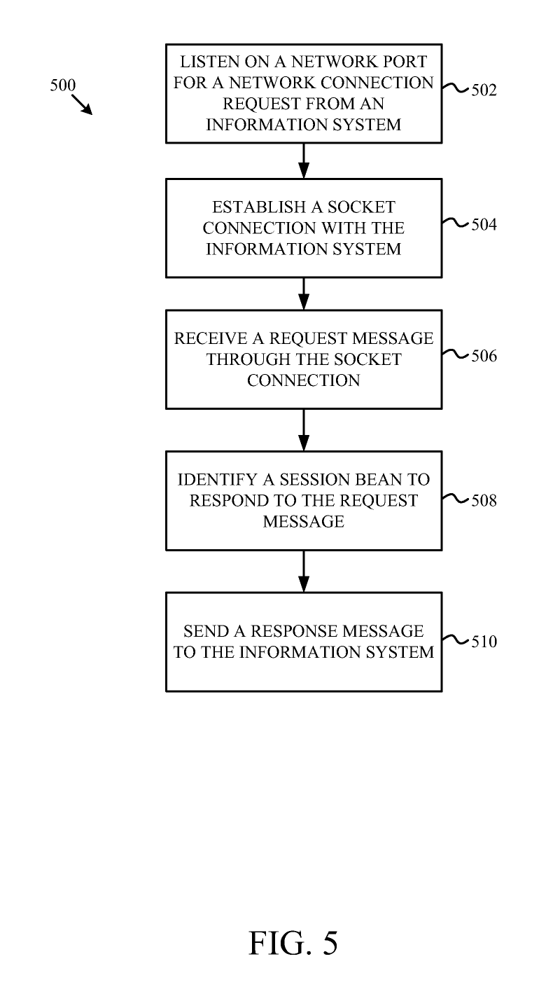

One method of handling request messages received at the resource adapter 422 is discussed with reference to FIG. 5. FIG. 5 is a flow chart illustrating a method for handling inbound communications with a resource adapter according to one embodiment. A method 500 begins at block 502 with a resource adapter listening on a network port for a network connection request from an information server. A listener thread may execute on a resource adapter at startup of the application server to listen for inbound messages.

At block 504 when a network connection request is received, the resource adapter establishes a socket connection with the information server. A worker thread may execute on the resource adapter to process requests from the information server coupled to the resource adapter through the socket connection. The worker thread may remain active until the socket connection is closed by the information server.

At block 506 a request message is received by the resource adapter through the socket connection. The request message may be decoded by the resource adapter. The request message may include a header having the overall message length, a validation identifier, a message version, and/or a task identifier. The header may also include other arguments for use by the requested task. The task identifier may identify the request message as a request to find a session bean, invoke a method, and/or release a session bean. According to one embodiment, a request message may have the header format listed in the table below.

| | | Size |
|---|---|---|
| Field Name | Description | (in bytes) |
| messageLength | Contains the overall byte length of a | 4 |
| | request message. | |
| validationID | Contains a unique value that can be | 1 |
| | quickly checked to verify that request | |
| | message is from a valid source. This field | |
| | may be set to 127. | |
| messageVersion | Contains a value to identify the message | 1 |
| | format version. This value should be | |
| | changed each time the message format is | |
| | changed. The field may initially be set to | |
| | 1. | |
| taskID | Contains a value that indentifies a task to | 2 |
| | be performed. | |
| | Possible values are: | |
| | Find_Bean: 1 | |
| | Invoke_Method: 2 | |
| | Release_Bean: 3 | |

In the event the request message is a find bean request message, the request message header may be followed by arguments for JNDI Name, Login Configuration Name, UserName, and Password. The Java naming and directory interface (JNDI) name argument may identify the JNDI name of the session bean to find. The Login Configuration Name argument may identify the Java authentication and authorization service (JAAS) configuration for use to authenticate the provided user name and password provided in the UserName and Password arguments, respectively.

In the event the request message is an invoke method request message, the request message header may be followed by arguments for Method Name and Method Arguments. The Method Name argument may be a string argument that defines the name of the session bean method to invoke. The Method Arguments arguments may be a series of zero or more arguments that match the signature of the specified method name.

In the event the request message is a release bean request message, the request message header may not be followed by any arguments.

At block 508 a session bean is identified on the application server to respond to the request message. While identifying a session bean, a session bean may be instantiated or created in the application server to respond to the request message. The session bean may perform calculations requested by the information server and/or access databases requested by the information server.

At block 510 a response message is sent from the resource adapter to the information server. The response message may include a header having an overall message length, a validation identifier, a message version, and a status. A status value of zero may indicate that the requested task completed successfully. A status value of one may indicate that an error has occurred in the requested task. If an error is detected, a string argument having a description of the error may be placed after the response header. If no error is detected, data produced by the requested task may follow the response header. According to one embodiment, a response message may have the header format listed in the table below.

| | | Size |
|---|---|---|
| Field Name | Description | (in bytes) |
| messageLength | Contains the overall byte length of a | 4 |
| | response message. | |
| validationID | Contains a unique value that can be | 1 |
| | quickly checked to verify that response | |
| | message is from a valid source. This field | |
| | may be set to 64. | |
| messageVersion | Contains a value to identify the message | 1 |
| | format version. This value may be | |
| | changed each time the message format | |
| | is changed. The field may initially be | |
| | set to 1. | |
| status | Contains a value that indicates if a task | 2 |
| | has completed successfully. | |
| | Possible values: | |
| | No_Error: 0 | |
| | Fatal_Error: 1 | |

As described above, one or more arguments may follow a request message and/or a response message. An argument descriptor format according to one embodiment is described in the table below.

| | | Size |
|---|---|---|
| Field Name | Description | (in bytes) |
| dataType | Contains the data type of an argument. | 1 |
| valueLength | Contains the byte length of the argument value | 4 |
| | located immediately after the argument | |
| | descriptor. | |

Data types for an argument may include integers, floating numbers, strings, Boolean values, and/or other data types listed in the table below. According to one embodiment, the data type of an argument may be identified by placing an identifier in the dataType argument field according to the table below.

| | Data Type | | Size (in |
|---|---|---|---|
| Data Type | ID | Description. | bytes) |
| Byte | 1 | 1 byte, signed (e.g., two's complement). | 1 |
| | | Range: −128 to 127 | |
| Short | 2 | 2 bytes, signed (e.g., two's complement). | 2 |
| | | Range: −32,768 to 32,767 | |
| Integer | 3 | 4 bytes, signed (e.g., two's complement). | 4 |
| | | Range: −2,147,483,648 to 2,147,483,647. | |
| Long | 4 | 8 bytes, signed (e.g., two's complement). | 8 |
| | | Range: −9,223,372,036,854,775,808 to | |
| | | 9,223,372,036,854,775,807. | |
| Boolean | 5 | 0 equates to false and 1 equates to true | 1 |
| String | 7 | An ASCII string value encoded using the resource | variable |
| | | adapter CharacterSet configuration property. | |
| Big_Decimal | 10 | A BigDecimal consists of an arbitrary precision long | 12 |
| | | integer unscaled value and a 32-bit integer scale. If | |
| | | zero or positive, the scale is the number of digits to | |
| | | the right of the decimal point. If negative, the | |
| | | unscaled value of the number is multiplied by ten to | |
| | | the power of the negation of the scale. The argument | |
| | | value is an 8 byte unscaled value followed by a 4 byte | |
| | | scale. | |
| Big_Integer | 11 | 9 bytes, signed (e.g., two's complement) | 9 |
| List | 14 | A list of values with a data type ID of 1-15, and 17-19. | 4 |
| | | The value of a List argument is the number of | |
| | | entries in the list. The arguments following a List | |
| | | argument contains the values for the list entries. | |
| Map | 15 | A Map of key/value pairs with a data type ID of 1-15, | 4 |
| | | and 17-19. The value of a Map argument is the | |
| | | number of entries in the map. The arguments | |
| | | following a Map argument will be argument pairs that | |
| | | represent the key and the value for each map entry. | |
| Void | 16 | A special type used to indicate that a method does not | 0 |
| | | define a return value. | |
| Null | 17 | A special type used to indicate that a method return | 0 |
| | | value is null. | |
| Float_S | 18 | String representation of a float value. | variable |
| | | Range: 1.40129846432481707e−45 to | |
| | | 3.40282346638528860e+38 (positive or negative). | |
| Double_S | 19 | String representation of a double value. | variable |
| | | Range: 4.94065645841246544e−324d to | |
| | | 1.79769313486231570e+308d (positive or negative). | |
| Object | 70 | A special type used to indicate that a method return | 4 |
| | | value is a user-defined class type. A user-defined | |
| | | class type can contain fields defined using a data type | |
| | | ID of 1-15, and 17-19. The value of an Object | |
| | | argument is the number of fields in the object | |
| | | instance. | |
| Field | 71 | A special type used to identify a field value in an | variable |
| | | object. The value of a Field argument is the Java | |
| | | name for the field. Immediately after the field name | |
| | | is an argument that contains the field value. | |

In the event the response message is a find bean response message the response message header may not be followed by any arguments.

In the event the response message is an invoke method response message, the response message header may be followed by at least one argument if the task completes successfully. According to one embodiment, the at least one argument may be one of the Data Type from 1-17 or 70 as illustrated in the table above. If the task completes with an error, a string argument may follow the invoke method response message header describing the error.

In the event the response message is a release bean response message the response message header may not be followed by any arguments. If an error occurred in the bean the response message may include an argument describing the error following the response message header.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
listening on a network port for a network connection request from an information server;
establishing a socket connection with the information server after the network connection request is received;
receiving a request message through the socket connection;
identifying a session bean to respond to the request message; and
sending a response message to the information server.

2. The method of claim 1, in which the network port is configurable by an administrator.

3. The method of claim 1, in which receiving the request message comprises receiving an identifier of the session bean and arguments for the session bean.

4. The method of claim 3, in which the response message comprises a header having a status indicating whether the session bean has completed successfully.

5. The method of claim 4, in which when the session bean fails the status comprises a description of an error encountered by the session bean.

6. The method of claim 4, in which when the session bean executes successfully the response message further comprises a data response.

7. The method of claim 1, in which the request message comprises at least one of a find bean request, an invoke method request, and a release bean request.

8. The method of claim 1, further comprising performing user authentication before sending the response message.

9. The method of claim 1, further comprising maintaining the state of the session bean after sending the response message.

10. The method of claim 1, in which the response message sent to the information server is delivered to a mobile device.

11. An application server, comprising:
a container for performing operations for an information server; and
a resource adapter for processing an inbound connection from the information server and an outbound connection to the information server.

12. The application server of claim 11, in which the container creates session beans to perform the operations.

13. The application server of claim 11, in which the outbound connection couples the resource adapter to a database of the information server.

14. The application server of claim 11, in which the inbound connection couples the resource adapter to a JavaScript routine executing on the information server.

15. The application server of claim 11, in which the resource adapter is configured to decode a request message received through the inbound connection.

16. The application server of claim 11, in which the resource adapter is configured to generate a response message through the outbound connection.

17. A computer program product, comprising
a computer-readable medium comprising:
code to listen on a network port for a network connection request from an information server;
code to establish a socket connection with the information server after the network connection request is received;
code to receive a request message through the socket connection;
code to identify a session bean to respond to the request message; and
code to send a response message to the information server.

18. The computer program product of claim 17, in which the medium further comprises code to perform user authentication before sending the response message.

19. The computer program product of claim 17, in which the code to send the response message sends a header with a status of the session bean and, if the session bean is successful, a data response.

20. The computer program product of claim 17, in which the code to receive the request message comprises code to decode at least one of a find bean request, an invoke method request, and a release bean request.
